(19) United States
(12) Patent Application Publication
(10) Pub. No.: US 2012/0015200 A1
(43) Pub. Date: Jan. 19, 2012

(54) ANTIMICROBIAL COATINGS

(75) Inventors: Mahfuza B. Ali, Mendota Heights, MN (US); Naiyong Jing, Woodbury, MN (US); Valeri Lirine, Brighton, MA (US); Pradnya V. Nagarkar, Weston, MA (US); Caroline M. Ylitalo, Stillwater, MN (US); Nancy S. Lennhoff, North Andover, MA (US)

(73) Assignee: 3M Innovative Properties Company

(21) Appl. No.: 13/115,143

(22) Filed: May 25, 2011

Related U.S. Application Data
(60) Provisional application No. 61/348,157, filed on May 25, 2010.

(51) Int. Cl. B32B 9/04; B05D 3/02; B05D 5/00; B05D 7/00

(52) U.S. Cl. 428/447; 427/314

(57) ABSTRACT

The disclosure provides siliceous substrates with the antimicrobial compositions coated thereon. The disclosure also includes methods of coating articles with the antimicrobial compositions. The methods include heat treating the siliceous substrate not more than four hours prior to contacting the antimicrobial composition with the heat-treated substrate.

### CROSS REFERENCE TO RELATED APPLICATIONS

This application claims the benefit of U.S. Provisional Patent Application No. 61/348,157, filed on May 25, 2010, which is incorporated herein by reference in its entirety.

### BACKGROUND

Touch panels can be found in applications from ATM's to casinos to point of sale terminals and portable computers. Touch panels have become more and more popular as input devices for computers. A touch is sensed by a touch panel when a finger or a stylus comes into contact with the outermost surface of the touch panel. The contact is translated into x and y coordinates of the finger or stylus on the panel. Some touch panels are transparent overlays placed over a display. Other touch panels are non-transparent devices typically used to control cursor movement for example on a portable computer, or as pen input devices for applications including writing or signature input to a computer. Since the data entry is based on contact, touch panels are inherently susceptible to scratches and to microbial contamination.

The environments in which touch panels are used expose the touch panels to microbial colonization and damage. These panels provide a suitable home for bacteria, fungi, algae, and other one celled organisms which thrive and propagate based on the availability of appropriate amounts of moisture, temperature, nutrients, and receptive surfaces. As these organisms metabolize, they produce chemical by-products. These chemicals are known to etch the touch sensitive panels, producing odors. Further, the biomass of such colonies fog or obscure the optical properties of the panels, irreparably damaging the touch panel. Cleaning and disinfection with chemicals which leach and poison the organisms and environmental controls which minimize moisture have, to date, been the response to this problem. Although cleaning and disinfection is common practice, it is done with the knowledge of the risks of sub-lethal dose levels, ineffective doses, resistant organisms, environmental exposure, human exposure, and the limited duration of such cleaners after the initial treatment. Indeed, scratches which do not destroy the panel itself may provide a safe haven for the bacteria despite attempts to wipe the panel to remove such microorganisms.

Typical touch screen panels, e.g., capacitive touch screen panels, require direct contact with the skin of the user's finger. Thus, these panels are directly contacted by many different users. As these organisms thrive, the variety of chemicals that these organisms produce are also known affect the human user. Thus, these microorganisms, as well as their metabolic products can pose serious health risks to users ranging from minor skin irritation to more serious toxic response and disease. With the increased popularity of such touch panels, the public is becoming increasingly aware of and concerned with the presence of microorganisms on these panels and the potential consequences resulting from contact with such contaminated surfaces.

In addition to microbial contamination, the sometimes harsh environments in which they are used expose touch panels to scratching from coins, bottles and glasses as well as exposing them to harsh outdoor elements where they are subject to airborne debris and even vandalism. Depending on the severity of the scratch, the function of the display may be greatly affected. Surface scratches affect product appearance and function in detrimental ways. This is especially true in the optics and display industry where the display surface is coated with a layer or layers intended to provide a specific function such as a filter or dielectric coating. In particular, computer touch screen panels are especially vulnerable.

The foregoing concerns demonstrate growing detrimental effects of microorganisms on computer touch panels and a need for controlling microorganisms that may be disposed on such touch sensitive panels. The use of environmental controls has limited effectiveness on microorganism prevention in part because of the wide variety of environmental conditions under which various microorganisms can survive and in part because of the costs and difficulty of actually keeping moisture levels sufficiently low to minimize microbial growth.

There exists a need for simple means to prevent the colonization of articles by microorganisms and/or a means to reduce the number of living microorganisms that become disposed on a surface such as a touch panel, for example.

### SUMMARY

In view of the general need to control the number of viable microorganisms on a surface that is intentionally touched by its user, the present disclosure provides a process and an antimicrobial composition that can be used, in some embodiments, to form a coating that is bonded to a surface (e.g., a touch-sensitive surface). The antimicrobial coating may include chemical components that impart other desirable properties (e.g., adhesive properties, scratch resistance properties, antistatic properties) for the article on which it is applied. In some embodiments, the components of the antimicrobial coating may be selected for their optically-transparent properties.

Thus, in one aspect, the present disclosure provides a method of making a coated article. The method can comprise heat-treating a siliceous substrate and contacting the siliceous substrate with a first composition comprising a quaternary ammonium compound and an organosilane. Heat-treating the siliceous substrate can comprise heating the siliceous substrate for a sufficient period of time and at sufficient temperature to remove volatile surface impurities. Contacting the siliceous substrate with the first composition can comprise contacting the siliceous substrate with the first composition not more than 4 hours after heat-treating the glass substrate.

In any embodiment of the method, the first composition further can comprise an adhesion-promoting reagent. In any of the above embodiments, the first composition further can comprise a catalyst. In any of the above embodiments, the first composition further can comprise water. In any of the embodiments, the water further can comprise acidified water.

In any of the above embodiments, the quaternary ammonium compound can comprise N,N-dimethyl-N-(3-(trimethoxysilyl)propyl)-1-octadecanaminium chloride. In any of the above embodiments, the organosilane compound can comprise 3-chloropropyltrimethoxysilane.

In any of the above embodiments, the first composition further can comprise an antimicrobial polymer having a plurality of pendant groups comprising a first pendant group comprising a first quaternary ammonium component, a second pendant group comprising a nonpolar component, and a third pendant group comprising a first organosilane component.

In any of the above embodiments, prior to contacting the first composition with the siliceous substrate, the method further can comprise contacting a second composition comprising an adhesion-promoting reagent in a solvent with the siliceous substrate under conditions suitable to form covalent linkages between the adhesion-promoting reagent and the siliceous substrate.

In another aspect, the present disclosure provides an article. The article can comprise a siliceous substrate comprising a surface, a first layer coated on the surface, and a second layer coated on the first layer. The first layer can comprise an adhesion-promoting reagent and the second layer can comprise a quaternary ammonium compound and an organosilane. In any embodiment of the article, the first or second layer further can comprise a catalyst. In any of the above embodiments of the article, the adhesion-promoting reagent can be selected from the group consisting of 3-triethoxysilyl-N-(1,3-dimethyl-butyliden)propylamine, N-phenyl-3-aminopropyltrimethoxysilane, and 3-[2-(2-aminoethylamino)ethylamino]propyl-trimethoxysilane, 3-aminopropyltrimethoxysilane, 3-aminopropyltriethoxysilane, 3-(2-aminoethyl)aminopropyltrimethoxysilane, (amino ethylaminomethyl)phenethyltrimethoxysilane, (amino ethylaminomethyl) phenethyltriethoxysilane, N-(2-aminoethyl)-3-aminopropylmethyldimethoxysilane, bis-(γ-triethoxysilylpropyl) amine, N-(2-aminoethyl)-3-aminopropyltributoxysilane, 6-(aminohexylaminopropyl)trimethoxysilane, 4-aminobutyltrimethoxysilane, 4-aminobutyltriethoxysilane, p-(2-aminoethyl) phenyltrimethoxysilane, 3-aminopropyltris(methoxyethoxyethoxy)silane, 3-aminopropylmethyldiethoxysilane, tetraethoxysilane and oligomers thereof, methyltriethoxysilane and oligomers thereof, an oligomeric aminosilane, 6, 3-(N-methylamino)propyltrimethoxysilane, N-(2-aminoethyl)-3-aminopropylmethyldimethoxysilane, N-(2-aminoethyl)-3-aminopropylmethyldiethoxysilane, N-(2-aminoethyl)-3-aminopropyltrimethoxysilane, N-(2-aminoethyl)-3-aminopropyltriethoxysilane, 3-aminopropylmethyldiethoxysilane, 3-aminopropylmethyldimethoxysilane, 3-aminopropyldimethylmethoxysilane, and 3-aminopropyldimethylethoxysilane.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, an article comprising “a” siliceous substrate can be interpreted to mean that the article can include “one or more” siliceous substrates.

The term “and/or” means one or all of the listed elements or a combination of any two or more of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The invention will be further explained with reference to the drawing figures listed below, where like structure is referenced by like numerals throughout the several views.

FIG. 1a is a top perspective view of an embodiment of an antimicrobial touch screen article, with a capacitive layer, according to the present disclosure.

FIG. 1b is a top perspective view of an embodiment of an antimicrobial touch screen article, without a capacitive layer, according to the present disclosure.

FIG. 2 is a top perspective view of another embodiment of an antimicrobial touch screen article according to the present disclosure.

FIG. 3 is a top perspective view of another embodiment of an antimicrobial touch screen article according to the present disclosure.

FIG. 4 is a block diagram of one embodiment of a method of making a coated article according to the present disclosure.

### DETAILED DESCRIPTION

Polymeric materials are provided that can contain a plurality of different pendant groups. Methods of making the polymeric material and compositions that contain the polymeric material are also provided. Additionally, articles with coatings that contain the polymeric material are provided. The polymeric material in the coatings is often crosslinked. The coatings can be antimicrobial, scratch-resistant, or both.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting. The use of “including,” “comprising,” “containing,” or “having” and variations thereof herein is meant to encompass the items listed thereafter and equivalents thereof as well as additional items. Unless specified or limited otherwise, the terms “supported,” and “coupled” and variations thereof are used broadly and encompass both direct and indirect supports and couplings. It is to be understood that other embodiments may be utilized and structural or logical changes may be made without departing from the scope of the present disclosure. Furthermore, terms such as “front,” “rear,” “top,” “bottom,” and the like are only used to describe elements as they relate to one another, but are in no way meant to recite specific orientations of the apparatus, to indicate or imply necessary or required orientations of the apparatus, or to specify how the invention described herein will be used, mounted, displayed, or positioned in use.

The term “antimicrobial” refers to material that kills microorganisms or inhibits their growth.

The term “silane” refers to a compound having four groups attached to a silicon atom. That is, the silane has a silicon-containing group.

The term “alkoxysilyl” refers to a silicon-containing group having an alkoxy group bonded directly to the silicon atom. The alkoxysilyl can be, for example, of formula—Si(OR)(Rx)₂ where R is an alkyl and each Rx is independently a hydroxyl, alkoxy, alkyl, perfluoroalkyl, aryl, aralkyl, or part of a silicone.

The term “ester equivalent” means groups such as silane amides (RNR′Si), silane alkanoates (RC(O)OSi), Si-0-Si, SiN(R)—Si, SiSR and RCONR′Si that are thermally and/or catalytically displaceable by R″OH. R and R′ are independently chosen and can include hydrogen, alkyl, arylalkyl, alkenyl, alkynyl, cycloalkyl, and substituted analogs such as alkoxyalkyl, aminoalkyl, and alkylaminoalkyl. R″ may be the same as R and R′ except it may not be H.

The term “hydroxysilyl” refers to a silicon-containing group having a hydroxyl group bonded directly to the silicon atom. The hydroxysilyl can be, for example, of formula—Si(OH)(Rx)₂ where Rx is an alkyl, perfluoralkyl, aryl, aralkyl, alkoxy, hydroxyl, or part of a silicone. A compound having a hydroxysilyl group is often referred to as a “silanol”. Silanols are a subset of silanes.

The term “silicone” refers to a moiety that contains a silicon-oxygen-silicon linkage group. Any other suitable groups can be attached to the silicon atoms. Such a linkage can result from the reaction of a first silane (e.g., a first silicon-containing group such as a first alkoxysilyl group or hydroxysilyl group) with a second silane (e.g., a second silicon-containing group such as a second alkoxysilyl group or hydroxysilyl group). In some embodiments, the silicone is part of a “silicone network”. A silicone network results when a first silane (i.e., a first silicon-containing group) reacts with a second silane (e.g., a second silicon-containing group) plus a third silane (e.g., a third silicon-containing group such as a third alkoxysilyl group or hydroxysilyl group) or when a first silane (e.g., a first silicon-containing group) reacts with a second silane (e.g., a second silicon-containing group) plus a third silane (e.g., a third silicon-containing group) and a fourth silane (e.g., a fourth silicon-containing group such as a fourth alkoxysilyl group or hydroxysilyl group).

As used herein, the phrases “polymeric material with a plurality of pendant groups”, “polymeric material with multiple pendant groups”, “antimicrobial polymer” or similar phrases are used interchangeably to refer to a polymeric material that has at least three different types of pendant groups. The multiple pendant groups include (1) a first pendant group containing a quaternary amino group; (2) a second pendant group containing a nonpolar group; and (3) a third pendant group having an organosilane group. The polymeric material with multiple pendant groups can be crosslinked through a condensation reaction of multiple organosilane groups. Furthermore, the polymeric material can be covalently coupled to a surface comprising a silanol group or, preferably, a plurality of silanol groups. Examples of such polymeric material can be found in U.S. Provisional Patent Application No. 61/348,044.

The present disclosure is generally directed to articles comprising an antimicrobial coating and methods of making said articles comprising an antimicrobial coating. The articles further comprise a siliceous substrate (e.g., glass or a glass-coated material). In some embodiments, the substrate comprises a touch-sensitive substrate (e.g., a computer display touch panel). The touch-sensitive substrate may comprise an active portion. The active portion of the substrate includes a surface configured to be touched (e.g., by a finger, a stylus, or the like). “Active portion” is used herein in the broadest sense and refers to a region of the substrate that can transduce a tactile stimulus into an electrical signal. Nonlimiting examples of devices that comprise a substrate with an “active portion” include touch screens (e.g., computer touch screens, personal digital assistant touch screens, telephone touch screens, card reader touch screens, casino gaming devices, touch-enabled industrial equipment controls, touch-enabled vehicle accessory controls, and the like) Exemplary touch screens are disclosed in U.S. Pat. Nos. 6,504,582; 6,504,583; 7,157,649; and U.S. Patent Application Publication No. 2005/0259378.

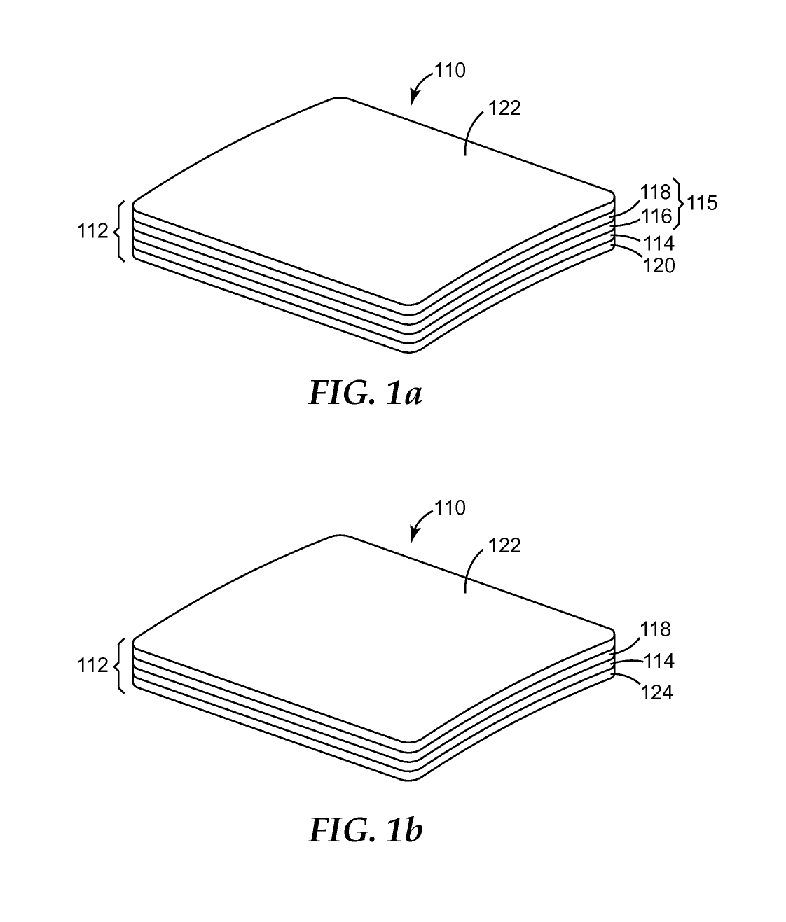

Turning to the Figures, FIG. 1a shows one embodiment of an antimicrobial touch sensor 110 according to the present invention. The touch sensor 110 may be a touch sensitive panel such as, for example, a “surface capacitive” computer touch panel, available from 3M Touch Systems, Methuen, Mass., made up of several different layers. The touch sensor 110 features an antimicrobial touch panel 112.

Touch panel 112 includes electrically insulative substrate 114. Insulative substrate 114 may be constructed from glass, plastic or another transparent medium, for example. The touch panel 112 further comprises a touch-sensitive active portion 115 on the insulative substrate 114. Active portion 115 includes a transparent, electrically conductive layer 116 deposited directly on substrate 114. Conductive layer 116, for example, can be a tin oxide layer having a thickness of twenty to sixty nanometers and may be deposited by sputtering, vacuum deposition and other techniques known in the art. The thickness of the layers is exaggerated in FIG. 1a for illustrative purposes only and is not intended to represent the layers to scale. Conductive layer 116 may also include a conductive polymeric material or a conductive organic-inorganic composite.

A conductive pattern, not shown, can be disposed about the perimeter of conductive layer 116 to provide a uniform electric field throughout the layer 116 in order to establish the point of contact between the panel 112 and a finger or stylus.

Active portion 115 may also include protective layer 118 deposited over conductive layer 116 to provide abrasion resistance to protect conductive layer 116. Protective layer 118 may be a layer of an organosiloxane formed by applying to the article a composition (e.g., a solution) comprising methyltriethoxysilane, tetraethylorthosilicate, isopropanol and water. Additionally, or alternatively, the protective layer may comprise a hardcoat material (e.g., the glare-resistant hardcoat described in Example 1 of U.S. Pat. No. 7,294,405).

Second conductive layer 120 may be provided to shield touch sensor 110 from noise which may result from the electric circuits of a display unit, not shown, to which display 110 may be attached and may similarly include a tin oxide layer deposited in a similar manner as discussed with reference to conductive layer 116. However, conductive layer 120 is not a necessary limitation of the invention as touch sensor 110 can function without it.

Antimicrobial layer 122 in accordance with this disclosure is coupled to active portion 115, usually on protective layer 118 or even directly to conductive layer 116 if protective layer 118 is not present or to the outermost layer, if additional layers (not shown) are present to reduce energy dissipation of an object contacting touch sensor 110. “Antimicrobial layer”, as used herein, refers to a coated layer comprising an antimicrobial compound (e.g., a quaternary ammonium compound) coupled (adhered) to the substrate via covalent bonds (e.g., Si—O—Si bonds), ionic bonds, hydrogen bonds, and/or hydrophobic interaction. Additionally, the antimicrobial layer may comprise two or more antimicrobial compounds that are coupled to each other via coavalent bond, ionic bonds, and/or by hydrophobic interaction. The coupled compounds may be coupled to the substrate via covalent bonds (e.g., Si—O—Si bonds), ionic bonds, and/or hydrophobic interaction. Optionally, the antimicrobial layer may further comprise an organosilane compound that is coupled to the substrate and/or the quaternary ammonium compound via covalent bonds (e.g., Si—O—Si bonds), ionic bonds, and/or hydrophobic interaction.

Advantageously, antimicrobial layers of the present disclosure can further confer other desirable properties on the coated substrate. For example, the ionic properties of the quaternary ammonium compound in the layer can bestow anti-static properties to the coated substrate. Furthermore, the quaternary ammonium compound and the organosilane compound can bestow scratch-resistance properties to the coated substrate.

In this configuration, antimicrobial layer 122 can minimize or prevent damage to touch sensor 110, providing an easy glide experience to the touch screen user, as well as inhibit the survival and growth of microorganisms which come to rest on touch sensor 110.

FIG. 1b shows one embodiment of another antimicrobial touch sensor 110 according to the present invention. The touch sensor 110 may be a touch sensitive panel such as, for example, a “projected capacitive” computer touch panel in a projected capacitive touch screen, made up of several different layers. The touch sensor 110 features an antimicrobial touch panel 112.

Touch panel 112 includes electrically insulative substrate 114. Insulative substrate 114 may be constructed from glass, plastic or another transparent medium, for example.

A conductive layer 124 can be disposed beneath the substrate 114 in order to establish the point of contact between the panel 112 and a finger or stylus. In some embodiments (not shown), conductive layer 124 may be a plurality of conductive layers (e.g. arrays of electrodes) with dielectric layers disposed there between. Touch sensors with this configuration are disclosed in U.S. patent application Ser. No. 12/652,343.

Touch panel 112 may also include protective layer 118 deposited over insulative substrate 114 to provide abrasion resistance to protect insulative substrate 114. Protective layer 118 may be a layer of an organosiloxane formed by applying to the article a composition (e.g., a solution) comprising methyltriethoxysilane, tetraethylorthosilicate, isopropanol and water. Additionally, or alternatively, the protective layer may comprise a hardcoat material (e.g., the glare-resistant hardcoat described in Example 1 of U.S. Pat. No. 7,294,405).

Antimicrobial layer 122 in accordance with this disclosure is coupled to protective layer 118 or even directly to insulative substrate 114 if protective layer 118 is not present or to the outermost layer, if additional layers (not shown) are present to reduce energy dissipation of an object contacting touch sensor 110. In this configuration, antimicrobial layer 122 can minimize or prevent damage to touch sensor 110, providing an easy glide experience to the touch screen user, as well as inhibit the survival and growth of microorganisms which come to rest on touch sensor 110.

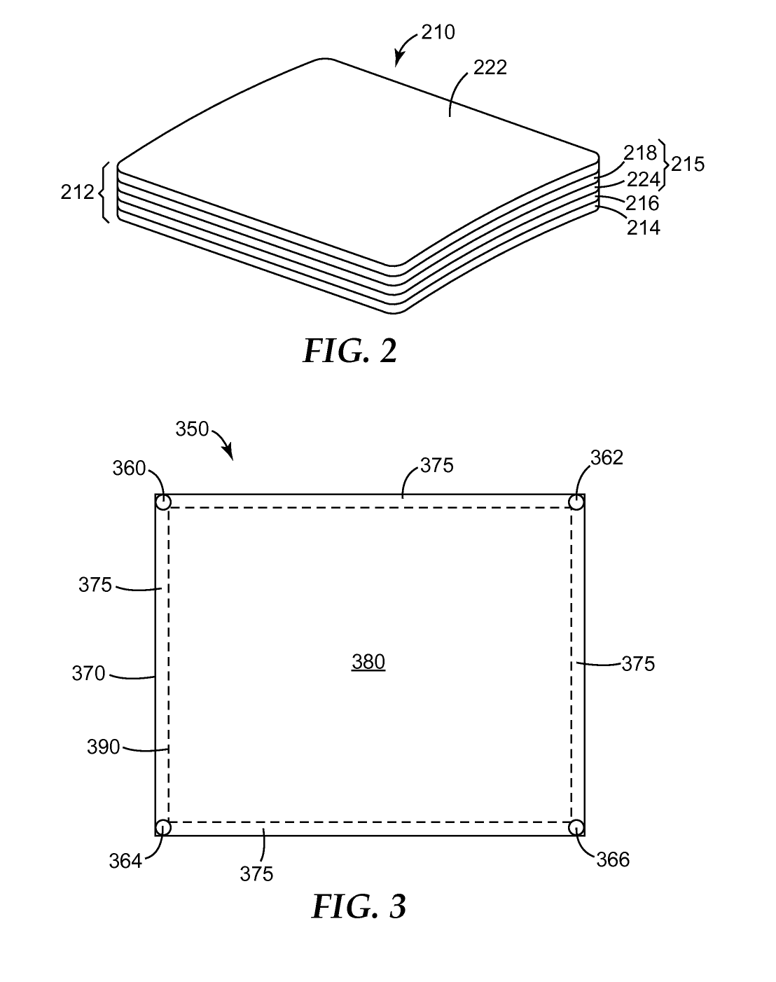

FIG. 2 shows another embodiment of a touch sensor 210. The touch sensor 210 may include, for example, a resistive computer touch panel 212, available from Elo TouchSystems, Freemont, Calif., which includes insulative substrate 214 and conductive layer 216, similar to FIG. 1a. Protective layer 218 may include a hard coating which protects and supports deformable conductive layer 224 interposed between conductive layer 216 and protective layer 218. A nonlimiting example of a suitable hard coating includes the glare-resistant hardcoat described in Example 1 of U.S. Pat. No. 7,294,405. As touch sensor 210 is contacted by a finger or stylus deformable conductive layer 224 compresses and makes contact with conductive layer 216 to indicate the position of the contact. Antimicrobial layer 222 is applied to protective layer 218.

FIG. 3 shows one embodiment of a vibration-sensing touch sensor 350 that includes a rectangular touch plate 370 and vibration sensors 360, 362, 364, and 366 located at the corners and coupled to the touch plate. When integrated into a system, for example overlaying an electronic display, the border portion 375 of touch sensor 350 may be covered by a bezel, leaving an intended touch area 380 exposed to a user. Dashed line 390 is used to indicate a separation between the border area 375 and the intended touch area 380. Dashed line 390 is an arbitrary designator, and does not necessarily indicate that touches outside of its inscribed area cannot be detected. To the contrary, dashed line 390 merely inscribes an area where touch inputs are intended or expected to occur, which may include the entire touch plate or some portion or portions thereof. When dashed lines are used in this document to designate intended touch areas, they are used in this manner. Antimicrobial layers (not shown) of the present disclosure can be applied directly or indirectly to the surface of the touch area 380 of the vibration-sensing touch sensor 350. An example of indirect application includes applying the antimicrobial layer to one side of a polymer film and a pressure-sensitive adhesive to the other side of the film; then applying the adhesive side of the film to the touch area of the vibration-sensing touch sensor.

While the touch plate is shown as rectangular in FIG. 3, it can be of any arbitrary shape. The touch plate can be glass, acrylic, polycarbonate, metal, wood, or any other material cable of propagating vibrations that can be caused or altered by a touch input to the touch plate and that can be sensed by the vibration sensors. To detect the touch position in two dimensions on the touch plate, at least three vibrations sensors can be used, and are generally located at peripheral portions of the touch plate, although other locations can be used. For convenience, redundancy, or other reasons, it may be desirable to use at least four vibration sensors, for example one at each corner of a rectangular touch plate, as shown in FIG. 3. The vibration sensors can be any sensors capable of detecting vibrations in the touch plate that are caused or affected by a touch, for example bending wave vibrations.

Piezoelectric materials may provide exemplary vibrations sensors. The vibration sensors can be mechanically coupled to the touch plate by use of an adhesive, solder, or other suitable material. Conductive traces or wires (not shown) can be connected to each of the vibration sensors for communication with controller electronics (not shown). Exemplary vibration-sensing touch sensors, their operation, their components, and their layout on a sensor are disclosed in co-assigned U.S. Patent Application Publication No. 2004/0233174 and U.S. Patent Application Publication No. 2005/0134574.

### Antimicrobial Coatings:

The present disclosure provides antimicrobial coatings on a siliceous substrate. The antimicrobial coatings are formed by reacting, in suitable solvent (e.g., an organic solvent), compounds that comprise two or more chemical groups, each group serving one or more functional purposes (e.g., antimicrobial activity, coupling to a siliceous substrate, scratch-resistance, coupling to other compound, and/or coupling to a polymer component, if present) in the coating.

The antimicrobial activity can be tested using a standardized antimicrobial resistance test such as, for example, JIS-Z 2801 (Japanese Industrial Standards; Japanese Standards Association; Tokyo, Japan). The coatings further may have scratch-resistant properties. The scratch-resistant property of the coatings of the present disclosure can be tested using the ASTM test method D 7027.26676.

Coating compositions of the present disclosure are prepared in a first composition comprising any suitable solvent (e.g., an organic solvent such as isopropyl alcohol, for example that will solublize or make a dispersion of the compounds and, optionally, the polymeric components. Suitable solvents have a boiling point about 200° C. or lower and can be mixed with small portions (<10%, w/w) of acidified water without substantially degrading the solvent properties. Adding the acidified water to the solvent facilitates complete hydrolysis of silane groups which, in turn, optimizes the formation of —Si—O—Si— bonds between the silanated components (e.g., a silanated quaternary ammonium compound, an organosilane compound, a silanated antimicrobial polymer) in the first composition and/or the substrate. This can result in improved durability of antimicrobial coating on the substrate. Preferably, the solvent flashpoint is 100° C. or lower. Nonlimiting examples of suitable organic solvents include an alcohol (e.g., isopropyl alcohol, methanol), MEK, acetone, DMF, DMAC (dimethyl acetamide,) ethyl acetate, THF, etc. The components of the antimicrobial coating are mixed with the solvent and coated onto any suitable substrate described herein.

### Adhesion-Promoting Reagent:

In any embodiment the method of making an antimicrobial coating according the present disclosure, one or more adhesion-promoting reagent can be used in the process. In any embodiment, the adhesion-promoting reagent can be added with the antimicrobial component (e.g., a quaternary ammonium silane compound) to the first composition described herein. Suitable adhesion-promoting reagents include organosilane compounds having a silane group that can react to form Si—O—Si linkages and a leaving group (e.g. an alkoxy group).

The adhesion-promoting reagent can form Si—O—Si linkages with another organosilane compound (e.g., an unreacted quaternary ammonium silane compound), an organosilane-containing antimicrobial polymer, and/or a siliceous substrate (e.g., glass). Advantageously, the adhesion-promoting reagents promote improved adhesion of the antimicrobial components. Furthermore, the adhesion-promoting reagents promote improved durability of the antimicrobial coatings by increasing the number of covalent linkages between the antimicrobial compounds (and antimicrobial polymers, if present) and the substrate.

Nonlimiting examples of suitable adhesion-promoting reagents include N-2(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butyliden)propylamine, and N-phenyl-3-aminopropyltrimethoxysilane. In view of the present disclosure, other suitable adhesion-promoting reagents will be apparent to a person having ordinary skill in the art.

Other suitable adhesion-promoting reagents are disclosed in U.S. Patent Application Publication No. US 2008/0064825. For example, amino-substituted organosilane esters (e.g., alkoxy silanes) are preferred adhesion-promoting reagents. The antimicrobial articles of the present disclosure may be made by reacting an amino-substituted organosilane ester or ester equivalent and an antimicrobial polymer that has a plurality of polar functionalities combinatively reactive with the silane ester or ester equivalent. The amino-substituted organosilane ester or ester equivalent bears on the silicon atom at least one ester or ester equivalent group, preferably 2, or more preferably 3 groups. Ester equivalents are well known to those skilled in the art and include compounds such as silane amides (RNR′Si), silane alkanoates (RC(O)OSi), Si—O—Si, SiN(R)—Si, SiSR and RCONR′Si. These ester equivalents may also be cyclic such as those derived from ethylene glycol, ethanolamine, ethylenediamine and their amides. R and R′ are defined as in the “ester equivalent” definition herein.

3-aminopropyl alkoxysilanes are well known to cyclize on heating and these RNHSi compounds would be useful in this invention. Preferably, the amino-substituted organosilane ester or ester equivalent has ester groups such as methoxy that are easily volatilized as methanol so as to avoid leaving residue at the interface which may interfere with bonding. The amino-substituted organosilane must have at least one ester equivalent; for example, it may be a trialkoxysilane.

For example, the amino-substituted organosilane may have the formula: ZNH-L-SiX′X″X′″, where Z is hydrogen, alkyl, or substituted alkyl including amino-substituted alkyl; where L is a divalent straight chain C1-12 alkylene or may comprise a C3-8 cycloalkylene, 3-8 membered ring heterocycloalkylene, C2-12 alkenylene, C4-8 cycloalkenylene, 3-8 membered ring heterocycloalkenylene or heteroarylene unit. L may be interrupted by one or more divalent aromatic groups or heteroatomic groups. The aromatic group may include a heteroaromatic. The heteroatom is preferably nitrogen, sulfur or oxygen. L is optionally substituted with C1-4 alkyl, C2-4 alkenyl, C2-4 alkynyl, C1-4 alkoxy, amino, C3-6 cycloalkyl, 3-6 membered heterocycloalkyl, monocyclic aryl, 5-6 membered ring heteroaryl, C1-4 alkylcarbonyloxy, C1-4 alkyloxycarbonyl, C1-4 alkylcarbonyl, formyl, C1-4 alkylcarbonylamino, or C1-4 aminocarbonyl. L is further optionally interrupted by —O—, —S—, —N(Rc)—, —N(Rc)—C(O)—, —N(Rc)—C(O)—O—, —O—C(O)—N(Rc)—, —N(Rc)—C(O)—N(Rd)—, —O—C(O)—, —C(O)—O—, or —O—C(O)—O—. Each of Rc and Rd, independently, is hydrogen, alkyl, alkenyl, alkynyl, alkoxyalkyl, aminoalkyl (primary, secondary or tertiary), or haloalkyl; and each of X′, X″ and X′″ is a C1-18 alkyl, halogen, C1-8 alkoxy, C1-8 alkylcarbonyloxy, or amino group, with the proviso that at least one of X′, X″, and X′″ is a labile group. Further, any two or all of X′, X″ and X′″ may be joined through a covalent bond. The amino group may be an alkylamino group. Examples of amino-substituted organosilanes include 3-aminopropyltrimethoxysilane (SILQUEST A-1110), 3-aminopropyltriethoxysilane (SILQUEST A-1100), 3-(2-aminoethyl)aminopropyltrimethoxysilane (SILQUEST A-1120), SILQUEST A-1130, (aminoethylaminomethyl)phenethyltrimethoxysilane, (aminoethylaminomethyl) phenethyltriethoxysilane, N-(2-aminoethyl)-3-aminopropylmethyldimethoxysilane (SILQUEST A-2120), bis-(γ-triethoxysilylpropyl) amine (SILQUEST A-1170), N-(2-aminoethyl)-3-aminopropyltributoxysilane, 6-(aminohexylaminopropyl)trimethoxysilane, 4-aminobutyltrimethoxysilane, 4-aminobutyltriethoxysilane, p-(2-aminoethyl) phenyltrimethoxysilane, 3-aminopropyltris(methoxyethoxyethoxy)silane, 3-aminopropylmethyldiethoxysilane, oligomeric aminosilanes such as DYNASYLAN 1146, 3-(N-methylamino)propyltrimethoxysilane, N-(2-aminoethyl)-3-aminopropylmethyldimethoxysilane, N-(2-aminoethy 1)-3-aminopropylmethyldiethoxysilane, N-(2-aminoethy 1)-3-aminopropyltrimethoxysilane, N-(2-aminoethyl)-3-aminopropyltriethoxysilane, 3-aminopropylmethyldiethoxysilane, 3-aminopropylmethyldimethoxysilane, 3-aminopropyldimethylmethoxysilane, 3-aminopropyldimethylethoxysilane,

Additional “precursor” compounds such as a bis-silyl urea [RO)₃ Si(CH₂)NR]₂C═O are also examples of amino-substituted organosilane ester or ester equivalent that liberate amine by first dissociating thermally. The amount of aminosilane is between 0.01% and 10% by weight relative to the functional polymer, preferably between 0.03% and 3%, and more preferably between 0.1% and 1%.

In some embodiments, the adhesion-promoting reagents can be added to a coating mixture comprising a quaternary ammonium compound and, optionally, an organosilane compound, as disclosed herein, and contacted with a substrate (e.g., a glass substrate) under conditions that facilitate the formation of Si—O—Si linkages, as described herein. The coating mixture can be contacted with a suitable substrate, as described herein. Accordingly, the silane group in the adhesion-promoting reagent can link any silanated compound to another silanated compound (which may optionally be a component of a polymeric structure) or the substrate.

In some embodiments, the adhesion-promoting reagents can be added to a coating mixture comprising a polymer having a plurality of pendant groups that include a first pendant group that includes a first quaternary ammonium component, a second pendant group that includes a nonpolar component, and subsequently a third pendant group that includes an organosilane or organic silane ester component. The coating mixture can be contacted with a suitable substrate under conditions that facilitate the formation of Si—O—Si bonds, as described herein.

In an alternative embodiment, one or more adhesion-promoting reagent can be dissolved in an organic solvent and coated onto a suitable first substrate (e.g., glass) as described herein to form a first coating. After removal of the solvent by evaporation, the first substrate further comprises a layer (i.e., a “primer layer” or “adhesion-promoting” layer) of the adhesion-promoting reagent coated thereon. Subsequently, a composition (e.g., a solution) comprising any antimicrobial coating composition of the present disclosure in organic solvent can be coated onto the primer layer of the first substrate. After removal of the solvent by evaporation, the first substrate now comprises two layers, the “primer layer” and the antimicrobial polymer layer. The first substrate, now comprising two coated layers, can be heated (e.g., to about 120 degrees C. for about 3 minutes to about 15 minutes) to facilitate the formation of Si—O—Si bonds and, thereby, covalently couple the silanated components of the coating mixture to the first substrate. In an alternative embodiment, the primer layer comprising the adhesion-promoting reagent can be heated under conditions that facilitate the formation of Si—O—Si bonds prior to contacting the first composition with the coated first substrate.

### Catalysts:

In any embodiment the method of making an antimicrobial coating according the present disclosure, one or more catalyst can be used in the process. Suitable catalysts include any compound that promotes the formation of Si—O—Si bonds. Nonlimiting examples of suitable catalysts include an acid (e.g., an organic acid), a base (e.g., an organic base), tin octoate and 1,8-Diazabicycloundecene (DBU). In any embodiment, the catalyst can be added with the antimicrobial component and the adhesion-promoting reagent, if present, to the first composition described herein.

In use, the catalyst can be dissolved in the first composition, second composition, first mixture and/or second mixture described herein. Typically, the final concentration of the catalyst in any coating composition is relatively low (e.g., about 0.04 weight percent). A person of ordinary skill in the art will recognize that the concentration of the catalyst should be sufficiently high enough to catalyze the cross-linking reaction, while avoiding substantial interference with the optical properties (e.g., color) of the coating and/or interference with the shelf-life of the coating mixture.

### Substrates and Articles:

Antimicrobial layers of the present disclosure can be applied to a variety of siliceous substrates. Useful substrates include, for example, siliceous materials such as glasses, glass coatings, and siliceous ceramic materials.

The substrates can be used to fabricate a variety of useful articles (e.g., as a part, a portion, or the entirety of the article). The articles comprise a variety of surfaces that may be deliberately or incidentally contacted with microbiologically-contaminated items during routine use. The articles include, for example, electronic displays (e.g., computer touch screens). Suitable articles may be found in food-processing environments (e.g., food-processing rooms, equipment, countertops) and health care environments (e.g., patient care rooms, countertops).

### Methods of Preparing Antimicrobial-Coated Articles:

The present disclosure provides methods for coating antimicrobial coating compositions of the present disclosure onto a substrate. The solution (i.e., the reaction mixture) comprising at least one antimicrobial component in organic solvent can be contacted with a substrate. The solvent can be evaporated to leave a durable antimicrobial coating on the substrate. In some embodiments, the substrate can be heated before and/or during the contacting step to accelerate the evaporation of the solvent. Preferably, the substrate is heated to a temperature that does not degrade a function (e.g., antimicrobial activity, scratch-resistance) of the antimicrobial layer or a component of the subtrate onto which the antimicrobial coating composition is coated. A suitable temperature for contacting the polymer composition on a glass subtrate is from room temperature to about 120° C. A person of ordinary skill in the art will recognize that higher temperatures will facilitate faster removal of organic solvent from the polymer composition.

In some embodiments, the antimicrobial component can be diluted to a final concentration of 1 wt. % to about 20 wt % in the organic solvent before using the diluted solution to coat the antimicrobial coating composition onto a substrate. In some embodiments, the antimicrobial component is diluted to a final concentration of 1 wt % to about 5 wt % in the organic solvent before using the diluted solution to coat the antimicrobial coating composition onto a substrate. Suitable organic solvents to dilute the polymer have a flashpoint below 150° C. and include ethers, ketones esters and alcohols, for example, isopropyl alcohol.

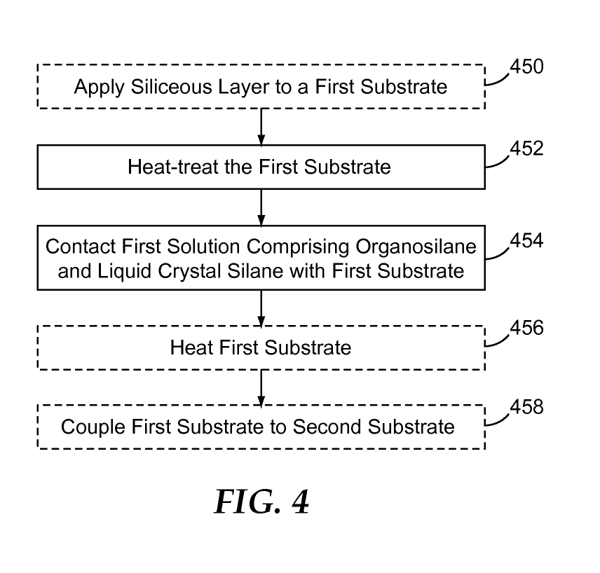

Turning back to the drawings, FIG. 4 shows one embodiment of a method of preparing a coated article according to the present disclosure. This method can result in particularly high durability of an antimicrobial coating applied to glass or a siliceous surface. The method includes the optional step 450 of applying a siliceous layer to a first substrate. The first substrate may be any suitable substrate described herein to which a siliceous layer may be applied. In some embodiments, the first substrate may be a glass-coated polymer film or a diamond-like glass material. The siliceous layer may be applied to the first substrate using methods that are known to a person of ordinary skill in the art. A nonlimiting example of applying a siliceous layer to a substrate is described in Example 1 of U.S. Pat. No. 7,294,405; wherein an antiglare hard coat siliceous layer is applied to a glass substrate.

The method further includes the step 452 preparing the first substrate. The first substrate can comprise a siliceous material such as a glass layer, a glass coating on a thermoduric substrate (e.g. a metal), or glass particles. The first substrate can be prepared by a heat treatment for a sufficient period of time and at sufficient temperature suitable remove volatile surface impurities such as water and organic residues (e.g., hydrocarbons, lipids, oils, organic solvents), for example. A skilled person will recognize that it is the combination of both time and temperature that render the treatment suitable to remove volatile surface impurities from the substrate.

Suitable heat treatments to prepare the substrate include exposing the siliceous substrate to a temperature from about 475 to about 550 degrees C. In some embodiments, the heat treatment is a duration of at least about 3 minutes or longer. In some embodiments, the heat treatment is for a duration of about 3 minutes to about 10 minutes. In some embodiments, the heat treatment is for a duration of about 6 minutes to about 10 minutes.

Other suitable heat treatments include, for example, exposing the siliceous substrate to a temperature of about 130 degrees C. for about 30 minutes. For example a relatively thick (e.g. about 2 mm or thicker) siliceous substrate can be heated to about 475 to about 550 degrees C. In particular, heating the substrate from about 100 degrees to about 150 degrees for 20 minutes to 60 minutes can improve the bonding between the antimicrobial components and the substrate. In some embodiments, heating the substrate shortly before the antimicrobial coating composition is applied results in improved bonding (e.g., as measured by the durability of the coating) between the coating and the substrate. The improved bonding can result in significantly greater durability of the antimicrobial layer on the substrate. This can be demonstrated, for example, using the Eraser Test described herein. Without being bound by theory, it is believed that pretreatment of the substrate by heating removes excess moisture present on the surface of the substrate (e.g., siliceous material) and provides greater ability of the surface silane groups to react with the organosilane groups in the antimicrobial coating composition.

Without being bound by theory, it is believed that the heat treatment removes water and other impurities (e.g., organic residues) from the surface of the siliceous material, making it more reactive with silane compounds.

The method further comprises the step 454 of contacting a first composition comprising an organosilane (e.g., an antimicrobial organosilane), which optionally may include an antimicrobial polymer (e.g., the antimicrobial polymer disclosed in U.S. Provisional Patent Application No. 61/348,157), and a liquid crystal silane (e.g., a homeotropic liquid crystal silane) with the first substrate. Suitable diamond-like glass materials are described in U.S. Pat. Nos. 6,696,157; 6,015,597; and 6,795,636; and U.S. Patent Application Publication No. US 2008/196664. Preferably, the composition comprises an antimicrobial quaternary ammonium group as an organosilane component.

In some embodiments, a relatively small portion (e.g., 3%) of the solvent comprises acidified water. Acidified water in the antimicrobial coating composition further can facilitate the formation of bonds between silane groups.

The first composition may be applied the substrate using a variety of processes known in the art such as, for example, wiping, brushing, dip coating, curtain coating, gravure coating, kiss coating, spin coating, and spraying.

Contacting the first composition with the substrate further comprises contacting the first composition under conditions that facilitate the formation of Si—O—Si bonds. A person having ordinary skill in the art will appreciate that during and after the period which solvent of the first composition evaporates, components of the first composition will begin reacting with each other and/or with the siliceous substrate to form Si—O—Si bonds. This reaction will proceed relatively slowly at ambient temperature (circa 23° C.). Heating the substrate can facilitate the formation of cross-linking covalent bonds between the silane groups in the antimicrobial coating composition and the silane groups on the surface of the first substrate. Thus, in certain preferred embodiments, the formation of the Si—O—Si bonds can be accelerated by the optional step 456 of exposing the coated substrate to an elevated temperature. Without being bound by theory, other forces (e.g., hydrophobic interaction, adhesion) also may facilitate coupling of components of the antimicrobial coating composition to the first substrate.

In general, heating the first substrate to higher temperatures while contacting it with the first composition will require shorter times for the solvent to evaporate and for the antimicrobial component to bond to the first substrate. However, the contacting step should be performed at temperatures below which the siloxane bonds dissociate. For example, in some embodiments, the contacting step can be conducted at about ambient temperature (20-25° C.) for about 10 minutes to about 24 hours. In some embodiments, the contacting step can be conducted at about 130° C. for about 30 seconds to about 3 minutes.

The conditions for the contacting step 454 and or heating step 456 can have a significant impact on the properties of the antimicrobial coating on the substrate. For example, an antimicrobial coating composition contacted (“cured”) at room temperature for 24 hours can be measurably more hydrophobic than an antimicrobial coating composition cured at about 130° C. for about 3 minutes. In some embodiments, the hydrophobicity of the coating correlates with the durability of the antimicrobial layer coated onto the substrate.

In some embodiments, the method optionally includes post treatments (not shown) of the coating by heating or irradiations including IR plasma, E-beam for further improvement of interfacial adhesion of the coating to substrates. If the first substrate is heated during the contacting step 454, the method may include the step (not shown) of cooling the substrate. Typically, the substrate is cooled to room temperature.

In some embodiments, the method optionally includes the step 458 of coupling the first substrate to a second substrate. The first substrate may be coupled to the second substrate either before step 454 or after step 456. The second substrate may be any suitable substrate described herein. For example, the first substrate may be a polymer film to which an adhesive layer can be coated on one major surface of the film. In this embodiment, the antimicrobial layer may be applied to a first major surface of the film and an adhesive may be applied to the opposite major surface of the film. Thus, the film, with an antimicrobial layer on one major surface and an adhesive layer on the other major surface may subsequently be coupled via the adhesive layer to a second substrate such as a glass or polymer substrate, for example.

It should be noted that pretreatment of siliceous layers or substrates prior to applying antimicrobial coating compositions of the present disclosure can improve the bonding between the antimicrobial components and the substrate (e.g., siliceous material). Pretreatment of the siliceous layer or the substrate may include, for example, soaking the layer or the substrate in a volatile solvent (e.g., isopropyl alcohol) and/or wiping the layer or the substrate with the volatile solvent. Optionally, the solvent may further comprise a solution of a basic compound such as potassium hydroxide, for example. In some embodiments, the solvent may be saturated with the solution of the basic compound.

In any of the above embodiments (not shown), the method further can comprise coating the first substrate with a second composition comprising adhesion-promoting reagent prior to contacting the first substrate with the first composition. The first substrate can be any siliceous substrate disclosed herein. The adhesion-promoting reagent can be any adhesion-promoting reagent disclosed herein. Optionally, the second composition further can comprise a catalyst, as disclosed herein. In this embodiment, the adhesion-promoting reagent is dissolved in an organic solvent and coated onto a suitable first substrate (e.g., glass) as described herein to form a first coating. After removal of the solvent by evaporation, the first substrate further comprises a layer (i.e., a “primer layer” or “adhesion-promoting” layer) of the adhesion-promoting reagent coated thereon. Subsequently, a composition comprising any antimicrobial coating composition of the present disclosure in a suitable solvent can be coated onto the primer layer of the first substrate. After removal of the solvent by evaporation, the first substrate now comprises two layers, the “primer layer” and the antimicrobial composition layer. The first substrate, now comprising two coated layers, can be processed (e.g., heated to about 120 degrees C. for about 3 minutes to about 15 minutes) to facilitate the formation of Si—O—Si bonds, as disclosed herein. In an alternative embodiment, the primer layer comprising the adhesion-promoting reagent can be processed (e.g. heated or “cured”) to facilitate the formation of Si—O—Si bonds prior to contacting the first composition with the first substrate comprising the cured primer layer.

### EMBODIMENTS

Embodiment A is a method of making a coated article, the method comprising:
heat-treating a siliceous substrate;
contacting the siliceous substrate with a first composition comprising a quaternary ammonium compound and an organosilane compound;
wherein contacting the siliceous substrate with the first composition comprises contacting the siliceous substrate with the first composition not more than 4 hours after heat-treating the siliceous substrate.

Embodiment B is the method of embodiment A, wherein the first composition further comprises an adhesion-promoting reagent.

Embodiment C is the method of embodiment A or embodiment B, wherein the first composition further comprises a catalyst.

Embodiment D is the method of any one of the preceding embodiments, wherein the first composition further comprises water.

Embodiment E is the method of any one of the preceding embodiments, wherein the water further comprises acidified water.

Embodiment F is the embodiment of any one of the preceding embodiments, wherein the quaternary ammonium compound comprises N,N-dimethyl-N-(3-(trimethoxysilyl)propyl)-1-octadecanaminium chloride.

Embodiment G is the embodiment of any one of the preceding embodiments, wherein the organosilane compound comprises 3-chloropropyltrimethoxysilane.

Embodiment H is the method of any one of the preceding embodiments, wherein the first composition further comprises an antimicrobial polymer having a plurality of pendant groups comprising
a first pendant group comprising a first quaternary ammonium component;
a second pendant group comprising a nonpolar component; and
a third pendant group comprising a first organosilane component.

Embodiment I is the method of any one of embodiments A through H, further comprising:
contacting a second composition comprising an adhesion-promoting reagent in a solvent with the siliceous substrate under conditions suitable to form covalent linkages between the adhesion-promoting reagent and the siliceous substrate;
wherein contacting the second composition with the siliceous substrate occurs prior to contacting the first composition with the siliceous substrate.

Embodiment J is an article, comprising
a siliceous substrate comprising a surface;
a first layer coated on the surface, the first layer comprising an adhesion-promoting reagent; and
a second layer coated on the first layer, the second layer comprising a quaternary ammonium compound and an organosilane compound.

Embodiment K is the article of embodiment J, wherein the first or second layer further comprises a catalyst.

Embodiment L is the article of embodiment J or embodiment K K, wherein the adhesion-promoting reagent is selected from the group consisting of 3-triethoxysilyl-N-(1,3-dimethyl-butyliden)propylamine, N-phenyl-3-aminopropyltrimethoxysilane, and 3-[2-(2-aminoethylamino)ethylamino]propyl-trimethoxysilane, 3-aminopropyltrimethoxysilane, 3-aminopropyltriethoxysilane, 3-(2-aminoethyl)aminopropyltrimethoxysilane, (aminoethylaminomethyl)phenethyltrimethoxysilane, (aminoethylaminomethyl) phenethyltriethoxysilane, N-(2-aminoethyl)-3-aminopropylmethyldimethoxysilane, bis-(γ-triethoxysilylpropyl) amine, N-(2-aminoethyl)-3-aminopropyltributoxysilane, 6-(aminohexylaminopropyl)trimethoxysilane, 4-aminobutyltrimethoxysilane, 4-aminobutyltriethoxysilane, p-(2-aminoethyl) phenyltrimethoxysilane, 3-aminopropyltris(methoxyethoxyethoxy)silane, 3-aminopropylmethyldiethoxysilane, tetraethoxysilane and oligomers thereof, methyltriethoxysilane and oligomers thereof, an oligomeric aminosilane, 6, 3-(N-methylamino)propyltrimethoxysilane, N-(2-aminoethyl)-3-aminopropylmethyldimethoxysilane, N-(2-amino ethyl)-3-aminopropylmethyldiethoxysilane, N-(2-aminoethyl)-3-aminopropyltrimethoxysilane, N-(2-aminoethyl)-3-aminopropyltriethoxysilane, 3-aminopropylmethyldiethoxysilane, 3-aminopropylmethyldimethoxysilane, 3-aminopropyldimethylmethoxysilane, and 3-aminopropyldimethylethoxysilane.

The invention will be further illustrated by reference to the following non-limiting Examples. All parts and percentages are expressed as parts by weight unless otherwise indicated.

### Examples

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

A list of reagents used in the following examples in shown in Table 1.

TABLE 1

| Abbrevi- | | |
|---|---|---|
| ation | Chemical Name | Source |
| A-174 | Methacryloylpropyl trimethoxy | Aldrich; Milwaukee, |
| | silane | WI |
| AA | Acrylic acid | BASF; Florham, NJ |
| A1120 | N(beta-aminoethyl) gamma- | ShinEtsu; Akron, OH |
| | aminopropyltrimethoxysilane | |
| AEM5700 | A mixture of 3-(trimethoxysilyl)- | Aegis Environmental, |
| | propyldimethyloctadecyl ammonium | Midland, MI |
| | chloride (an organosilane liquid | |
| | crystal) and chloropropyltri- | |
| | methoxysilane (an organosilane) | |
| | in methanol | |
| BHT | 2,6-Di-tert-4-methyl phenol | Aldrich; Milwaukee, |
| | | WI |
| C₁₆H₃₃Br | 1-bromohexyl decane | Chemtura Corporation, |
| | | Bay Minette, AL |
| DMAEA | Dimethylaminoethyl acrylate | CIBA; Marietta, GA |
| DMAEA- | Dimethylaminoethyl acrylate C16 | See Example 2 |
| C16Br | bromide | |
| EtOAc | Ethyl acetate | J. T. Baker; Austin, |
| | | TX |
| EtOH | Ethanol | J. T. Baker; Austin, |
| | | TX |
| HEMA | Hydoxyethyl methacrylate | Cyro Industries; |
| | | Parsippany, NJ |
| IOA | Iso-octyl acrylate | Sartomer USA, LLC; |
| | | Exton, PA |
| IPA | Isopropyl alcohol | VWR; Houston, TX |
| MEHQ | 4-Methoxyphenol | Alfa Aesar, Ward Hill, |
| | | MA |
| NHMAc | N-(hydroxymethyl)-acrylamide | Aldrich; Milwaukee, |
| | | WI |
| NVP | N-Vinylpyrrolidinone | ISP Chemicals, Inc.; |
| | | Calvary City, KY |

### Example 1

### Physical Testing Methods for Coated Glass Substrates.

ASTM test methods are published by ASTM International (West Conshohocken, Pa.). The coated glass substrates were tested for a variety of physical properties. The hydrophobicity of the coated surface was tested by measuring the contact angle of a drop of deionized water using the ASTM D7334.7606 test method. The scratch resistance of the coated surface was tested using the ASTM D7027-05 test (“Scratch test”) with a constant load of 1000 g using Moh's hardness pens. The result is reported as the hardest pen that did not cause a scratch with the 1000 g load. The transmitted haze and transmittance of the polymer-coated glass substrates were measured using the ASTM D1003 on the Haze Gard Plus meter, from BYK-Gardner GmbH, Geretsried, Germany, and transmission is reported as the percent of light transmitted through the sample. The clarity was measured using a BYK-Gardner Haze Gard Plus instrument, calibrated using 0% (Black cover) standard and a clarity standard of 77.8% provided by BYK-Garner (catalog #4732). Reflected Haze is measured according to test method ASTM E430. Gloss at 20° and 60° was measured on a BYK Gloss meter using ASTM D523 test method.

The eraser rub test, which is a measurement of the durability of the coating, was performed according to the United States Military Specification for the Coating of Optical Glass Elements (MIL-C-675C) dated 22 Aug. 1980. The value reported is the number of eraser rubs required to remove the coating from the glass.

### Example 2

### Antimicrobial Activity Testing Methods for Coated Glass Substrates.

Antimicrobial activity of the coated glass substrates was tested using the JIS Z 2801 test method (Japan Industrial Standards; Japanese Standards Association; Tokyo, JP) was used to evaluate the antibacterial activity of antibacterial-coated glass substrates. The bacterial inocula (Staphylococcus aureus ATCC 6538, and Escherichia coli ATCC23573, respectively) were prepared in a solution of 1 part Nutrient Broth (NB) and 499 parts phosphate buffer. A portion of the inoculum was used to determine the number of viable bacteria in the inoculum. Another portion of the bacterial suspension (150 μL) was placed onto the surface of the glass sample and the inoculated glass sample was incubated for the specified contact time at 28+/−1° C. After incubation, the glass sample was placed into 20 ml of D/E Neutralizing Broth. The number of surviving bacteria in the Neutralizing broth was determined by inoculating the broth onto nutrient agar using a Spiral Plater WASP II, DW Scientific, Shipley, West Yorkshire, UK, incubating the plates for 24 hours at 35° C.±1° C. and counting the colonies using a colony reader (ProtoCol colony Counter; Microbiology International; Frederick, Md.).

### Example 3

### Synthesis of DMAEA-C₁₆Br Monomer

In a clean reactor; fitted with an overhead condenser, mechanical stirrer, and a temperature probe; were charged 546 parts of acetone, 488 parts of C₁₆H₃₃Br, 225 parts of DMAEA, 1.0 parts of BHT and 1.0 parts of MEHQ. The batch was stirred at 150 rpm and a mixed gas (90/10 O₂/N₂) was purged through the solution throughout the reaction scheme. The mixture was heated to 74° C. for 18 hours. A sample was taken out for analysis by GC and it revealed the conversion of >98% of the reactants to the desired product. At this point the reaction mixture heating was stopped and 1,000 parts of EtOAc was added slowly with stirring at very high speed. A white solid started to precipitate out. The mixture was allowed to cool to room temperature. The precipitate accumulated in the solution upon standing for couple of hours at room temperature. The reaction mixture was filtered and the white solid filtrate was washed with 1,000 parts of cold EtOAc. The white solid filtrate was dried in a vacuum oven at 40° C. for 8 hours. The solid material was analyzed by NMR spectroscopy, which revealed the presence of >99.9% pure DMAEA-C₁₆Br monomer.

### Comparative Examples 4-6

Method of Coating Antimicrobial Solutions onto a Glass Substrate.

Conductively-coated glass (part number 29617) was obtained from Pilkington North America, Inc. (Toledo, Ohio). A glare-resistant hardcoat was applied to the glass according to the method described in Example 1 of U.S. Pat. No. 7,294,405. The coated glass was cut into coupons, approximately 4″ by 4″ (10.2 cm by 10.2 cm), for coating and testing purposes.

Approximately two weeks later, AEM 5700 antimicrobial solution was diluted to 1 wt % in isopropyl alcohol and was applied to the glass samples using a wipe (Sealed Edge Wiper 6259HC; Coventry, Kennesaw, Ga.), which was used immediately to manually distribute the solution evenly over the surface of a glass coupon. After applying the antimicrobial solution, separate portions of the coated samples were heated to 120° C. for 3 minutes, 15 minutes, and 30 minutes, respectively, and then cooled to room temperature. After holding at room temperature for 24 hours, the samples were subjected to the Eraser Rub test described in Example 1.

The coated samples were then washed with soap (Optisolve OP7153-LF detergent; available from Kyzen North America (Manchester, N.H.) and deionized water in a 36″ Billco Versa Clean Washer (Billco Manufacturing, Inc., Zelienople, Pa.) with attached fluid head and roller wash pan and dried. The dried samples were tested as described below. After washing the coupons, the Eraser Rub test was repeated using a different portion of the coated glass sample. The samples were also tested to determine the contact angle of deionized water on the coated surface, as described above. The results are shown in Table 2.

### Examples 7-9

Method of Coating Antimicrobial Solutions onto a Pretreated Conductively-Coated Glass Substrate.

Conductively-coated glass was obtained and was coated with an anti-glare hardcoat as described in Comparative Examples 4-6. Not more than 4 hours before applying a 1 wt % solution of AEM 5700 (in IPA), as described in Comparative Examples 4-6, the glass samples were heated in a ten-zone convection oven (Model No. CSC #30842; Casso-Solar, Pomona, N.Y.) according to the profile shown in Table 2. After heating, the glass samples were cooled to room temperature.

TABLE 2
Heating profile for pre-treating the glass samples of Examples 7-9.

| | | | Zone |
|---|---|---|---|
| | Zone length | Exposure Time | Temperature |
| Zone | (m) | (minutes) | (° C.) |
| 1 | 3.05 | 3 | 615 |
| 2 | 3.05 | 3 | 545 |
| 3 | 3.05 | 3 | 506 |
| 4 | 3.05 | 3 | 483 |
| 5 | 3.05 | 3 | 475 |
| 6 | 3.05 | 3 | 430 |
| 7 | 7.62 | 7.5 | 486 |
| 8 | 7.62 | 7.5 | 455 |
| 9 | 7.62 | 7.5 | 340 |
| 10 | 7.62 | 7.5 | 175 |

The samples were subjected to the Eraser Rub test as described in Comparative Examples 4-6. The samples were also tested to determine the contact angle of deionized water on the coated surface, as described in Example 1. The results are shown in Table 2. The results indicate that, the glass samples (both washed and unwashed portions) that were exposed to longer periods of time at 120° C. were able to withstand a larger number of eraser rubs before the coating was rubbed off the glass substrate (i.e., the coating was more durable in the samples that were heated for longer periods). Furthermore, the samples heat-treated not more than four hours before applying the antimicrobial solution showed greater durability of the polymer coating, as measured by the Eraser Rub test.

TABLE 2
Durability of antimicrobial coatings on glass samples.

| | Contact | Eraser Rubs | Eraser Rubs |
|---|---|---|---|
| Sample | Angle | (before washing) | (after washing) |
| Comparative Example 4 | 81.66 | 28 | 20 |
| Comparative Example 5 | 82.75 | 68 | 52 |
| Comparative Example 6 | 91.13 | 87 | 54 |
| Example 7 | 72.23 | 38 | 25 |
| Example 8 | 76.69 | 95 | 65 |
| Example 9 | 89.51 | 107 | 68 |

### Preparative Examples 10-12

### Synthesis of Antimicrobial Polymers

In a clean reaction bottle, the monomers listed in Table 3 were combined with 0.5 parts of Vazo-67 and 300 parts of IPA. The mixture was purged with dry nitrogen for 3 minutes. The reaction bottle was sealed and placed in a 65° C. preheated water bath with mixing. The reaction mixture was heated for 17 hours at 65° C. with mixing. The viscous reaction mixture was analyzed for % solids. To drive the reaction of the residual monomer to >99.5% completion, an additional 0.1 parts of Vazo-67 was added to the mixture, the solution was purged and sealed. The bottle was placed in the 65° C. water bath with mixing and heated for 8 hours. A conversion of (>99.5%) of the monomers was achieved, as evident by % solids calculation. This process was used to make each of the polymers listed in Table 3.

TABLE 3
Antimicrobial polymers. The polymer designation refers to
the combination of monomers used in the reaction mixture.

| Preparative | | Monomer |
|---|---|---|
| Example # | Polymer Designation | Ratio |
| 10 | P(DMAEMA-C16Br/A-174/IOA) | 50/10/40 |
| 11 | P(DMAEMA-C16Br/HEMA/NHMAc/IOA | 50/10/10/30 |
| 12 | P(DMAEMA-C16Br/A-174/NVP/IOA) | 50/5/15/30 |

### Examples 13-17

Method of Coating Acidified Antimicrobial Solutions onto a Pretreated Conductively-Coated Glass Substrate.

Conductively-coated glass was obtained and was coated with an anti-glare hardcoat as described in Comparative Examples 4-6. Coating solutions are listed in Table 4. Acidified water was prepared by adding 1 drop of concentrated nitric acid into 25 milliliters deionized water. All coating solutions were made in IPA containing 3 wt % acidified water, with the exception of Example 16, which did not include the acidified water. All glass samples were heat-treated (as described for Examples 7-9) not more than 4 hours before applying the coating solutions listed in Table 4. The coating solutions were applied (using the wipe method described in Comparative Examples 4-6) and the coupons heated to 120° C. for 3-4 minutes, as described in Comparative Examples 4-6.

The samples were tested for antimicrobial activity against Staphylococcus aureus using ASTM test method 2149 (Example 1) and the results are shown in Table 5. The control glass was treated similarly to the coated samples, with the exceptions that no coatings were applied and, thus, the sample was not heated to 120° C. for 3-4 minutes.

TABLE 4
Compositions coated onto glass substrates.

| Example No. | Coating Mixture |
|---|---|
| 13 | 2.5 wt % of the polymer from Preparative Example 10 |
| | plus 0.5 wt % AEM5700 |
| 14 | 2.5 wt % of the polymer from Preparative Example 11 |
| | plus 0.5 wt % AEM5700 |
| 15 | 2.5 wt % of the polymer from Preparative Example 12 |
| | plus 0.5 wt % AEM5700 |
| 16 | 1 wt % AEM5700 (without acidified water) |
| 17 | 1 wt % AEM5700 |

TABLE 5
Antimicrobial activity of coated glass substrates.

| | Colony-forming units | Colony-forming units | |
|---|---|---|---|
| | (Log₁₀) | (Log₁₀) | Log₁₀ |
| Sample | 0 hr | 24 hr | Reduction |
| Example 13 | 6.68 | 3.62 | 3.06 |
| Example 14 | 6.72 | 5.12 | 1.6 |
| Example 15 | 6.65 | 3.28 | 3.37 |
| Example 16 | 6.45 | 2.73 | 3.72 |
| Example 17 | 6.86 | 3.12 | 3.74 |
| Control | 6.71 | 6.01 | 0.7 |

### Examples 18-33

Method of Coating an Adhesion-Promoting Solution and an Antimicrobial Solution onto a Pretreated Conductively-Coated Glass Substrate.

### Surface-Conductive Touch (SCT) Glass Substrate:

Conductively-coated glass was obtained and was coated with an anti-glare hardcoat as described in Comparative Examples 4-6. All coating solutions were made in IPA.

All glass samples were heat-treated (as described for Examples 7-9) not more than 4 hours before applying the coating solutions listed in Table 6. The coating solutions were applied (using the wipe method described in Comparative Examples 4-6).

Replicate glass samples were processed using one of the following methods:

Two coated layers—one cure process (Examples 18-21 and 26-29): Solution 1 was applied to the substrate and the solvent was evaporated at room temperature. Solution 2 was applied to the same portion of the substrate and the solvent was evaporated at room temperature. The substrate was placed in an oven at the final cure temperature for the period of time specified in Table 6. The substrate was removed from the oven and cooled at room temperature.
One coated layer—one cure process (Examples 22-23 and 30-31): The coating mixture was applied to the substrate and the solvent was evaporated at room temperature. The substrate was placed in an oven at the final cure temperature for the period of time specified in Table 6. The substrate was removed from the oven and cooled at room temperature.
Two coated layers—two cure process (Examples 24-25 and 32-33): Solution 1 was applied to the substrate and the solvent was evaporated at room temperature. The coated substrate was placed in an oven at 120° C. for 15 minutes and then cooled to room temperature. Solution 2 was applied to the same portion of the substrate and the solvent was evaporated at room temperature. The substrate was placed in an oven at the final cure temperature for the period of time specified in Table 6. The substrate was removed from the oven and cooled at room temperature.

After processing, the glass coupons were washed in a Billco washer as described in Comparative Examples 4-6, dried, and tested for antimicrobial activity according to the method described in Example 2. The results of the antimicrobial testing are presented in Table 7.

TABLE 6
Coating solutions for Examples 18-25.

| Example | | Final |
|---|---|---|
| # | Coating Solutions | Cure |
| 18 | Solution 1: A-1120, 1% in IPA | 120° C., |
| | Solution 2: CS3002, 3% in IPA | 3 min. |
| 19 | Solution 1: A-1120, 2% in IPA | 120° C., |
| | Solution 2: CS3002, 3% in IPA | 3 min. |
| 20 | Solution 1: A-1120, 1% in IPA | 120° C., |
| | Solution 2: CS3002, 3% in IPA | 10 min. |
| 21 | Solution 1: A-1120, 2% in IPA | 120° C., |
| | Solution 2: CS3002, 3% in IPA | 10 min. |
| 22 | 1:1 mixture of A-1120 (1% in | 120° C., |
| | IPA) and CS3002 (3% in IPA) | 15 min. |
| 23 | 1:1 mixture of A-1120 (2% in | 120° C., |
| | IPA) and CS3002 (3% in IPA) | 15 min. |
| 24 | Solution 1: A-1120, 1% in IPA | 120° C., |
| | Solution 2: CS3002, 3% in IPA | 3 min. |
| 25 | Solution 1: A-1120, 2% in IPA | 120° C., |
| | Solution 2: CS3002, 3% in IPA | 3 min. |

TABLE 6
Coating solutions for Examples 18-25. All data are reported as the
average results from testing three glass coupons per Example.

| | Log10 Reduction (CFU/mL) | Log10 Reduction (CFU/mL) |
|---|---|---|
| Example | after 2-hour contact time | after 2-hour contact time |
| # | (S. aureus) | (E. coli) |
| 18 | 2.22 | 3.36. |
| 19 | 2.33 | 3.65 |
| 20 | 2.56 | 3.44 |
| 21 | 5.10 | 4.97 |
| 22 | 5.10 | 3.27 |
| 23 | 2.41 | 3.85 |
| 24 | 5.10 | 4.97 |
| 25 | 5.10 | 4.11 |

The present invention has now been described with reference to several specific embodiments foreseen by the inventor for which enabling descriptions are available. Insubstantial modifications of the invention, including modifications not presently foreseen, may nonetheless constitute equivalents thereto. Thus, the scope of the present invention should not be limited by the details and structures described herein, but rather solely by the following claims, and equivalents thereto.

What is claimed is:

1. A method of making a coated article, the method comprising:
heat-treating a siliceous substrate;
contacting the siliceous substrate with a first composition comprising a quaternary ammonium compound and an organosilane compound;
wherein heat-treating the substrate comprises heating the substrate for a sufficient period of time and at sufficient temperature to remove volatile surface impurities;
wherein contacting the siliceous substrate with the first composition comprises contacting the siliceous substrate with the first composition no more than 4 hours after heat-treating the siliceous substrate.

2. The method of claim 1, wherein the first composition further comprises an adhesion-promoting reagent.

3. The method of claim 1, wherein the first composition further comprises a catalyst.

4. The method of claim 1, wherein the first composition further comprises water.

5. The method of claim 4, wherein the water further comprises acidified water.

6. The method of claim 1, wherein the quaternary ammonium compound comprises N,N-dimethyl-N-(3-(trimethoxysilyl)propyl)-1-octadecanaminium chloride.

7. The method of claim 1, wherein the organosilane compound comprises 3-chloropropyltrimethoxysilane.

8. The method of claim 1, wherein the first composition further comprises an antimicrobial polymer having a plurality of pendant groups comprising
a first pendant group comprising a first quaternary ammonium component;
a second pendant group comprising a nonpolar component; and
a third pendant group comprising a first organosilane component.

9. The method of claim 1, further comprising:
contacting a second composition comprising an adhesion-promoting reagent in a solvent with the siliceous substrate under conditions suitable to form covalent linkages between the adhesion-promoting reagent and the siliceous substrate;
wherein contacting the second composition with the siliceous substrate occurs prior to contacting the first composition with the siliceous substrate.

10. An article, comprising:
a siliceous substrate comprising a surface;
a first layer coated on the surface, the first layer comprising an adhesion-promoting reagent; and
a second layer coated on the first layer, the second layer comprising a quaternary ammonium compound and an organosilane compound.

11. The article of claim 10, wherein the first or second layer further comprises a catalyst.

12. The article of claim 10, wherein the adhesion-promoting reagent is selected from the group consisting of 3-triethoxysilyl-N-(1,3-dimethyl-butyliden)propylamine, N-phenyl-3-aminopropyltrimethoxysilane, and 3-[2-(2-aminoethylamino)ethylamino]propyl-trimethoxysilane, 3-aminopropyltrimethoxysilane, 3-aminopropyltriethoxysilane, 3-(2-aminoethyl)aminopropyltrimethoxysilane, (aminoethylaminomethyl)phenethyltrimethoxysilane, (aminoethylaminomethyl) phenethyltriethoxysilane, N-(2-aminoethyl)-3-aminopropylmethyldimethoxysilane, bis-(γ-triethoxysilylpropyl) amine, N-(2-aminoethyl)-3-aminopropyltributoxysilane, 6-(aminohexylaminopropyl)trimethoxysilane, 4-aminobutyltrimethoxysilane, 4-aminobutyltriethoxysilane, p-(2-aminoethyl) phenyltrimethoxysilane, 3-aminopropyltris(methoxyethoxyethoxy)silane, 3-aminopropylmethyldiethoxysilane, tetraethoxysilane and oligomers thereof, methyltriethoxysilane and oligomers thereof, an oligomeric aminosilane, 6, 3-(N-methylamino)propyltrimethoxysilane, N-(2-aminoethyl)-3-aminopropylmethyldimethoxysilane, N-(2-aminoethy 1)-3-aminopropylmethyldiethoxysilane, N-(2-aminoethy1)-3-aminopropyltrimethoxysilane, N-(2-aminoethyl)-3-aminopropyltriethoxysilane, 3-aminopropylmethyldiethoxysilane, 3-aminopropylmethyldimethoxysilane, 3-aminopropyldimethylmethoxysilane, and 3-aminopropyldimethylethoxysilane.
